(19) United States
(12) Patent Application Publication
(10) Pub. No.: US 2020/0028137 A1
(43) Pub. Date: Jan. 23, 2020

(54) ACCUMULATOR ARRANGEMENT

(71) Applicant: Mahle International GmbH, Stuttgart (DE)

(72) Inventors: Stefan Hirsch, Stuttgart (DE); Heiko Neff, Auenwald (DE); Holger Schroth, Maulbronn (DE)

(73) Assignee: Mahle International GmbH, Stuttgart (DE)

(21) Appl. No.: 16/515,207

(22) Filed: Jul. 18, 2019

(30) Foreign Application Priority Data
Jul. 19, 2018 (DE) 10 2018 212 099.4

(51) Int. Cl. H01M 2/10; B60L 50/64; B60L 50/60; B60K 1/04; H01M 2/02; H01M 10/48

(52) U.S. Cl. CPC H01M 2/1083; B60L 50/64; B60L 50/66; B60K 1/04; B60Y 2306/01; H01M 2/0237; H01M 10/48; H01M 2220/20; H01M 2/1077

(57) ABSTRACT

An accumulator arrangement with a plurality of battery modules for a motor vehicle may include an accumulator housing having a receiving space for receiving a plurality of battery modules. The accumulator housing may have a base and a wall. The accumulator arrangement may also include at least one energy receiving arrangement configured to receive an impact energy in case of an impact. The at least one energy receiving arrangement may include a wall part and a beam part. The wall part may include a plurality of first gripping elements aligned transversely to a wall direction. The beam part may include a plurality of second gripping elements aligned transversely to the wall direction. The plurality of first gripping elements and the plurality of second gripping elements may engage one another in an overlapping direction such that, in the case of an impact, the impact energy is received by the gripping elements.

### CROSS-REFERENCE TO RELATED APPLICATIONS

This application claims priority to German Patent Application No. DE 10 2018 212 099.4, filed on Jul. 19, 2018, the contents of which are hereby incorporated by reference in its entirety.

### TECHNICAL FIELD

The invention relates to an accumulator arrangement for a motor vehicle, and a motor vehicle with the accumulator arrangement.

### BACKGROUND

An accumulator arrangement is used in a motor vehicle as an energy store, in order for example to supply an electrically operated motor vehicle with energy. The accumulator arrangement usually has here several battery modules interconnected electrically with one another, which are fixed in a housing of the accumulator arrangement and are interconnected with one another electrically. Here, the housing protects the battery modules from external influences and usually consists of a housing upper shell and a housing lower shell. High requirements are set for the housing with regard to tightness owing to the partially very high voltages in the individual battery modules. In addition, the individual battery modules must be protected from damage in the case of an impact. For this, the housing is usually embodied so as to be very stable, whereby the weight of the housing is increased in a disadvantageous manner. In order to receive the impact energy in the case of an impact, longitudinal beam structures can be integrated in the housing. The longitudinal beam structures can disadvantageously only partially reduce the impact energy or respectively transfer it to transverse structures, or are expensive to manufacture.

### SUMMARY

It is therefore the object of the invention to indicate for an accumulator arrangement and for a motor vehicle with the accumulator arrangement of the generic type an improved or at least alternative embodiment, in which the described disadvantages are overcome.

This problem is solved according to the invention by the subject matter of the independent claim(s). Advantageous embodiments are the subject matter of the dependent claim(s).

An accumulator arrangement with several battery modules is provided for a motor vehicle and has an accumulator housing, which has a receiving space for receiving the respective battery modules. The accumulator housing has here a base and a wall projecting perpendicularly from the base in the wall direction. According to the invention, the accumulator arrangement has at least one energy receiving arrangement for receiving impact energy in the case of an impact with a wall part and with a beam part. The wall part forms here the wall of the accumulator housing or is fixed thereon, and the beam part is able to be fixed on a beam of the motor vehicle. The wall part has several first gripping elements oriented transversely to the wall direction, and the beam part has several second gripping elements oriented transversely to the wall direction, which engage into one another in overlapping direction. In the case of an impact, the impact energy can therefore be received by the gripping elements of the energy receiving arrangement in overlapping direction and can be transferred to a beam of the motor vehicle. The battery modules in the accumulator housing are thereby effectively protected from damage.

In the installed state, the accumulator arrangement is fixed on a body floor of the motor vehicle, wherein the wall of the accumulator housing is oriented in the Z-direction of the vehicle. Thereby, in the installed state of the accumulator arrangement, the wall direction corresponds to the vehicle Z-direction, and the overlapping direction corresponds to the vehicle X-direction or the vehicle Y-direction. In the installed state of the accumulator arrangement, the beam part is fixed on the beam of the motor vehicle, so that the wall of the accumulator housing and the beam are connected with one another via the energy receiving arrangement. The first gripping elements and the second gripping elements engage into one another in overlapping direction and have according to purpose an identical length in overlapping direction. In the case of an impact, the gripping elements move into one another in overlapping direction, so that the second gripping elements rest onto the wall of the accumulator housing and the first gripping elements rest onto a beam of the motor vehicle. By deforming of the gripping elements which are supported in such a way, the energy receiving arrangement can receive the impact energy and thereby the battery modules can be protected in the accumulator housing in the case of an impact. The characteristics of the energy receiving arrangement and its impact behaviour can be optimized for example by the material of the wall part and of the beam part, by the height of the gripping elements defined in wall direction, by the length of the gripping elements defined in overlapping direction, by the distance of the first gripping elements in wall direction or by the distance of the second gripping elements in wall direction.

In the accumulator arrangement, the wall part can be fixed on the wall of the accumulator housing, or can form the wall of the accumulator housing. The base of the accumulator housing can be both bearing and non-bearing here. In the case of a bearing base, the weight of the battery modules in the installed state of the accumulator arrangement is carried at least partially by the base. In the case of a non-bearing base, the weight of the battery modules can be carried for example by the body floor or by a cover fixed to the body floor. In addition, the base can be formed integrally with the wall of the accumulator housing or can be a separate component. Basically also further configurations of the accumulator housing are also conceivable.

In an advantageous further development of the accumulator arrangement, provision is made that the first gripping elements are fixed on a carrier plate of the wall part. The carrier plate extends here in the wall direction over an entire height and transversely to the wall direction over an entire length of the accumulator arrangement. The first gripping elements project from the carrier plate in overlapping direction and extend in addition transversely to the wall direction over an entire length of the carrier plate. The first gripping elements can be arranged in the wall direction at an equal or at an irregular distance from one another. Preferably, the carrier plate and the first gripping elements are metallic and the first gripping elements are welded or spot-welded to the carrier plate. The first gripping elements and the carrier plate can be produced for example from a sheet metal- or strip material, preferably from steel sheet or from aluminium sheet.

Advantageously, provision can be made that the carrier plate is formed by a Z-shaped or an L-shaped or a C-shaped or an I-shaped profile. The first gripping elements are then fixed on its crosspiece. When the profile has a flange, the latter can be fixed to a body floor. Thereby, in the installed state of the accumulator arrangement, the wall part can be fixed directly to a body floor of the motor vehicle for example by a screw connection. In addition, the rigidity of the carrier plate can be increased. When the profile has a further flange, then for example an underbody protection for protecting the battery modules from stone chippings can be fixed on it.

Advantageously, provision can be made that the respective first gripping elements are formed respectively by a strip which projects from the carrier plate in overlapping direction and is fixed to the carrier plate in a materially bonded manner. Alternatively thereto, respectively two of the first gripping elements, which are arranged adjacently, can be formed by flanges of a U-shaped profile. The profile can then be fixed with its crosspiece to the carrier plate in a materially bonded manner. The U-shaped profile is then fixed to the carrier plate in a manner which is open towards the beam part. Alternatively, provision can be made that the respective first gripping elements are formed by a folded plate which is fixed on one side to the carrier plate in a materially bonded manner. In this embodiment, the first gripping elements have a height in wall direction which is comparable with the length in overlapping direction, and can rest over a large area on a beam of the motor vehicle in the case of an impact.

In an advantageous further development of the accumulator arrangement, provision is made that the second gripping elements of the beam part are arranged into several gripping groups which are arranged adjacent to one another transversely to the wall direction. The respective gripping group of the second gripping elements extends here in wall direction over an entire height of the accumulator arrangement. The second gripping elements of the respective gripping group are, in addition, arranged at an equal or at an irregular distance with respect to one another in wall direction.

Advantageously, provision can be made that the respective gripping group is formed by a Ω-shaped profile. Here, the second gripping elements can be formed in a U-shaped central region of the profile. Angled ends of the profile can then be fixed to a beam of the motor vehicle. Alternatively, the respective gripping group can be formed by a grid plate with a frame and with a central region which is angled from the frame in overlapping direction. Here, the second gripping elements can be formed in the angled central region of the grid plate. The frame of the grid plate can then be fixed to a beam of the motor vehicle. In the above-mentioned configurations of the respective gripping group, the second gripping elements can be separated or respectively formed by through-cuts aligned transversely to the wall direction. The first gripping elements can then engage into these through-cuts in overlapping direction. Alternatively, provision can be made that the respective gripping group is formed by a carrier plate and a folded plate forming the respective second gripping elements, which is fixed to the carrier plate on one side in a materially bonded manner. When the carrier plate and the first gripping elements are metallic, then the first gripping elements can be welded or spot-welded to the carrier plate. Irrespective of the configuration of the second gripping group, the second gripping elements have a height in wall direction which is comparable with the length in overlapping direction, and can rest over a large area on the wall in the case of an impact.

In an advantageous further development of the accumulator arrangement according to the invention, provision is made that a height of the first gripping elements in wall direction corresponds to a distance of the second gripping elements in wall direction. Worded alternatively, a height of the second gripping elements in wall direction can correspond to a distance of the first gripping elements in wall direction. The first gripping elements and the second gripping elements then lie against one another at least on one side in wall direction, or respectively are stacked against one another alternately in wall direction. Advantageously, provision can be made that in the first gripping elements and/or in the second gripping elements tension anchor openings for a tension anchor are arranged lying over one another in wall direction. The first gripping elements and the second gripping elements can be braced with one another by the tension anchor. The tension anchor can be embodied here as a bolt or as a pin or as a screw or as a sheet metal strip.

Advantageously, provision can be made that the second gripping elements have respectively at least one ramp region, directed to the first gripping elements, for introducing the beam part into the wall part. The ramp region can extend here in certain areas in overlapping direction and can be directed to the first gripping elements. On assembling the energy receiving arrangement, the beam part can thereby be introduced into the wall part in a simplified manner. Provision can also be made that the first gripping elements and/or the second gripping elements respectively have a tooth-like region for engagement behind so that, on bringing together the beam part and the wall part, the first gripping elements and the second gripping elements do not engage behind one another and engage behind one another on separating of the beam part and the wall part transversely to the wall direction. In this way, in the case of an impact, the impact energy can be directed into the gripping elements and can thereby be received.

In summary, the energy receiving arrangement is able to be produced in a simple and favourably priced manner in the accumulator arrangement according to the invention. The first gripping elements and the second gripping elements engage into one another here, so that in the case of an impact the energy receiving arrangement can receive the impact energy and can transfer it effectively to a beam of the motor vehicle.

The invention also relates to a motor vehicle with the accumulator arrangement which is described above. The accumulator arrangement is fixed here beneath the motor vehicle on a body floor, wherein the beam part of the energy receiving arrangement is fixed on a beam of the motor vehicle. Here, the wall direction of the accumulator arrangement corresponds to the vehicle Z-direction, and the overlapping direction corresponds to the vehicle X-direction or to the vehicle Y-direction.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically

FIG. 1 shows a sectional view of a motor vehicle according to the invention with an accumulator arrangement according to the invention, in vehicle Y-direction;

FIG. 2 shows a sectional view of a motor vehicle according to the invention with an accumulator arrangement according to the invention, in vehicle X-direction;

FIGS. 3 to 5 show side views of differently configured energy receiving arrangements of the accumulator arrangement according to the invention in a disassembled state;

FIGS. 6 and 7 show side views of differently configured energy receiving arrangements of the accumulator arrangement according to the invention in an assembled state;

FIG. 8 shows a partial view of an accumulator arrangement according to the invention with an energy receiving arrangement;

FIG. 9 shows a partial view of an energy receiving arrangement in an accumulator arrangement according to the invention;

FIG. 10 shows a view of a beam part of the energy receiving arrangement shown in FIG. 9;

FIG. 11 shows a partial view of an energy receiving arrangement, configured in a variant manner, in an accumulator arrangement according to the invention;

FIG. 12 shows a view of a beam part of the energy receiving arrangement shown in FIG. 11.

### DETAILED DESCRIPTION

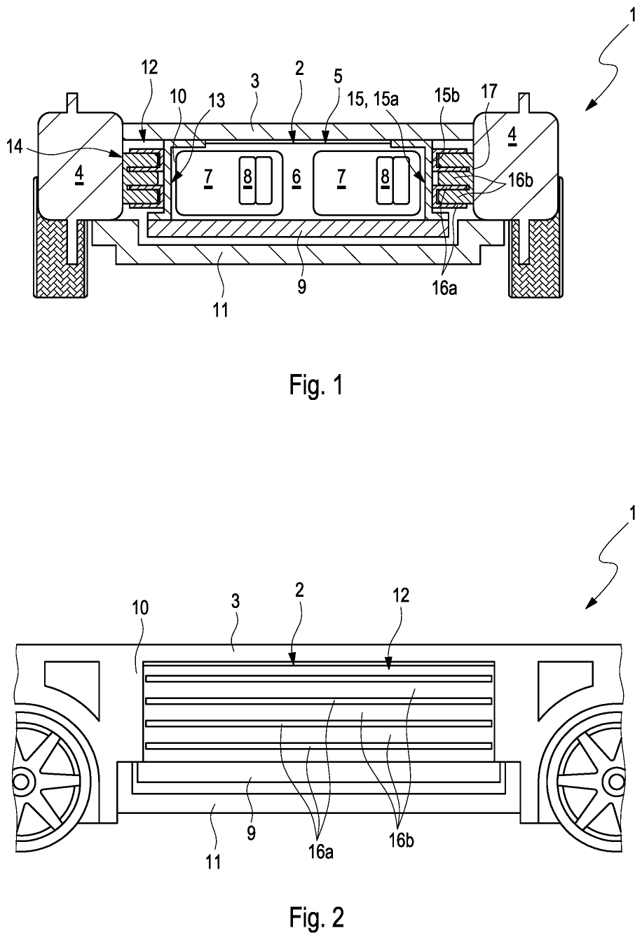

FIG. 1 shows a sectional view of a motor vehicle 1 according to the invention with an accumulator arrangement 2 according to the invention in vehicle Y-direction. In FIG. 2 a sectional view is shown of the motor vehicle 1 according to the invention with the accumulator arrangement 2 according to the invention in vehicle X-direction. The motor vehicle 1 has here a body floor 3 and two beams 4, which are fixed to the body floor 3 and are aligned in vehicle X-direction. Beneath the motor vehicle 1, the accumulator arrangement 2 is fixed to the body floor 3. The accumulator arrangement 2 has an accumulator housing 5, in which several battery modules 7 of several individual cells 8 are arranged. The accumulator housing 5 has here a base 9 and a wall 10, projecting perpendicularly from the base 9 in wall direction—which corresponds here to vehicle Z-direction. The accumulator housing 5 is protected from below from stone chippings by an underbody protection 11, which is fixed on the beams 4.

The accumulator arrangement 2 has on both sides respectively an energy receiving arrangement 12 for receiving impact energy in the case of an impact. The respective energy receiving arrangement 12 has a wall part 13 and a beam part 14. In this example embodiment, the wall part 13 is formed by a carrier plate 15 on which several first gripping elements 16a are fixed projecting in overlapping direction—which corresponds here to vehicle Y-direction. In this example embodiment, the carrier plate 15 is formed from a Z-shaped profile 15a and the gripping elements 16a are fixed to its crosspiece 15b. The carrier plate 15 extends here over an entire height of the wall 10 defined in vehicle Z-direction, and over an entire length of the accumulator arrangement 2 defined in vehicle X-direction. The first gripping elements 16a are arranged spaced apart with respect to one another in vehicle Z-direction and extend over the entire length of the carrier plate 15. In this example embodiment, the beam part 14 is formed by a carrier plate 17, on which several second gripping elements 16b are fixed projecting in overlapping direction—which corresponds here to vehicle Y-direction. The carrier plate 17 extends here over the entire height of the wall 10 and over the length of the accumulator arrangement 2. The second gripping elements 16b are arranged spaced apart with respect to one another in vehicle Z-direction and extend over the entire length of the carrier plate 17. The wall part 13 is fixed to the wall 10 and the beam part 14 is fixed to the respective beam 4 of the motor vehicle 1. Thereby, the wall 10 of the accumulator housing 5 is connected to the respective beam 4 of the motor vehicle 1 via the energy receiving arrangement 12.

The first gripping elements 16a and the second gripping elements 16b engage into one another in vehicle Y-direction. A height of the first gripping elements 16a defined in vehicle Z-direction corresponds here to a distance of the second gripping elements 16b in vehicle Z-direction, so that the first gripping elements 16a and the second gripping elements 16b are stacked lying against one another in vehicle Z-direction. In addition, the gripping elements 16a and 16b have an identical length defined in vehicle Y-direction. In the case of an impact, the gripping elements 16a and 16b move into one another in vehicle Y-direction, so that the second gripping elements 16b rest onto the carrier plate 15 and the wall 10 of the accumulator housing 5, and the first gripping elements 16a rest onto the respective beam 4 of the motor vehicle 1. By deforming of the thus supported gripping elements 16a and 16b, the energy receiving arrangement 12 can receive the impact energy and thereby the battery modules 7 in the accumulator housing 5 can be protected in the case of an impact.

The characteristics of the energy receiving arrangement 12 and its impact behaviour can be optimized for example by the material of the material of the wall part 13 and of the beam part 14, by the height of the gripping elements 16a and 16b defined in vehicle X-direction, by the length of the gripping elements 16a and 16b defined in vehicle Y-direction, by the distance of the first gripping elements 16a in vehicle X-direction or by the distance of the second gripping elements 16b in vehicle X-direction. Preferably, the wall part 13 and the beam part 14 are metallic and the gripping elements 16a and 16b are welded or spot-welded to the corresponding carrier plates 15 and 17.

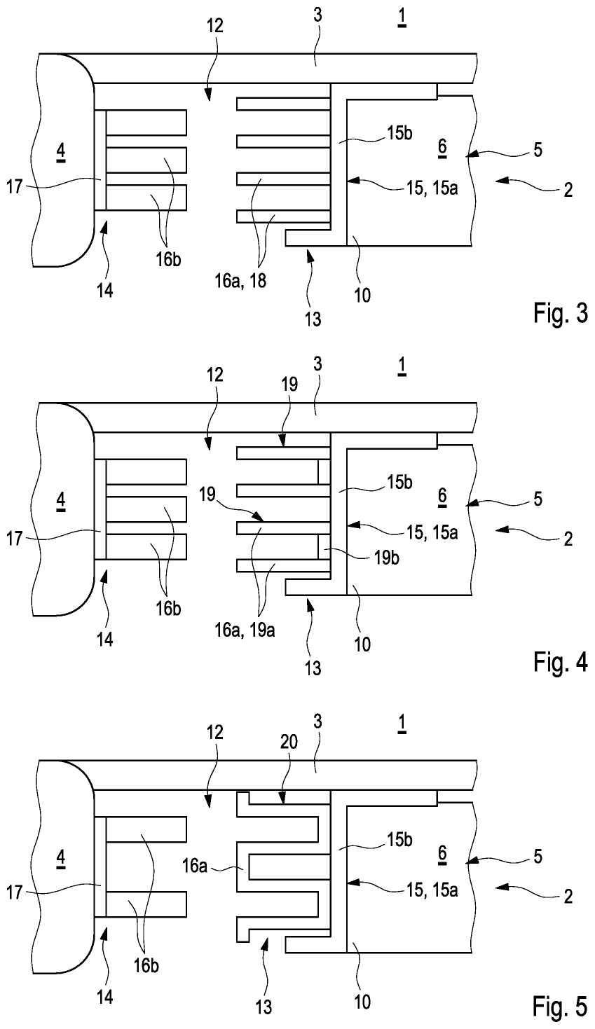

FIG. 3 to FIG. 5 show side views of the differingly configured energy receiving arrangements 12. In FIG. 3 the first gripping elements 16a of the wall part 13 are formed by respectively a strip 18, which projects from the carrier plate 15 in vehicle Y-direction. The strip 18 is fixed on the carrier plate 15 in a materially bonded manner. In FIG. 4 the first gripping elements 16a of the wall part 13 are formed by flanges 19a of a U-shaped profile 19. The respective profile 19 is fixed on the carrier plate 15 with its crosspiece 19b in a materially bonded manner and open towards the beam part 14. In FIG. 5 the first gripping elements 16a are formed by a folded plate 20, which is fixed on one side on the carrier plate 15 in a materially bonded manner. Here, the first gripping elements 16a have a height which is comparable to the length, and can rest over a large area on the beam 4 of the motor vehicle 1 in the case of an impact. Here, the beam part 14 is also adapted accordingly, so that the first gripping elements 16a and the second gripping elements 16b can engage into one another.

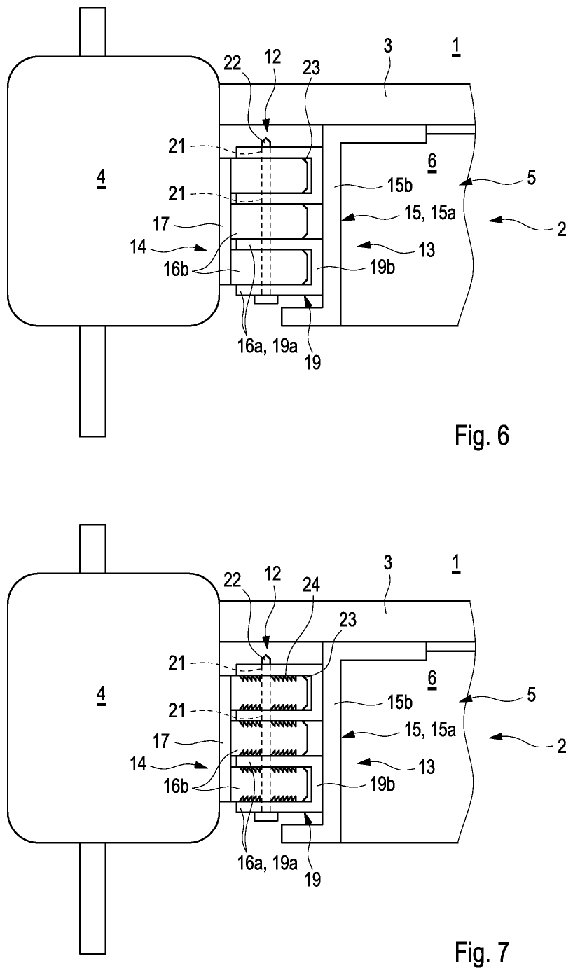

FIGS. 6 and 7 show side views of the differently configured energy receiving arrangements 12. Here, the gripping elements 16a and 16b have several tension anchor openings 21 lying over one another in vehicle Z-direction. In the tension anchor openings 21 a tension anchor 22 is arranged, which braces the first gripping elements 16a and the second gripping elements 16b with one another. The second gripping elements 16b have, in addition, a ramp region 23, directed to the first gripping elements 16a, for introducing the beam part 14 into the wall part 13. The wall part 13 is formed here corresponding to the wall part 13 in FIG. 4. Deviating from the beam part 14 shown in FIG. 6, the second gripping elements 16b of the beam part 14 in FIG. 7 have on both sides a tooth-like region 24 for engagement behind. Through the respective regions 24 for engagement behind, the first gripping elements 16a and the second gripping elements 16b can engage behind one another on separating of the beam part 14 and of the wall part 13, in vehicle Y-direction. In this way, in the case of an impact, the impact energy can be directed more effectively into the gripping elements 16a and 16b.

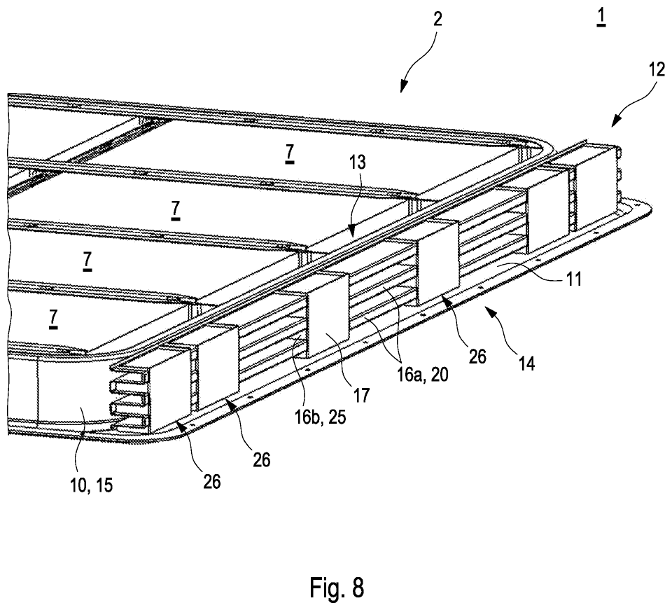

FIG. 8 shows a partial view of the accumulator arrangement 2 according to the invention. In this example embodiment, the second gripping elements 16b are arranged into several gripping groups 26 arranged adjacent to one another in vehicle X-direction. The respective gripping group 26 of the second gripping elements 16b extends here over the entire height of the accumulator arrangement 2. The respective gripping groups 26 form together the beam part 14. In this example embodiment, the respective gripping group 26 has respectively the carrier plate 17, on which the second gripping elements 16b are formed by a folded plate 25. The folded plate 25 is fixed here on the respective carrier plate 17 in a materially bonded manner. The wall part 13 is formed here similarly to the wall part 13 shown in FIG. 5 and has a carrier plate 15 with the folded plate 20 fixed on it in a materially bonded manner. In this example embodiment, the carrier plate 15 is formed by the wall 10, and the folded plate 20 is fixed directly on the wall 10.

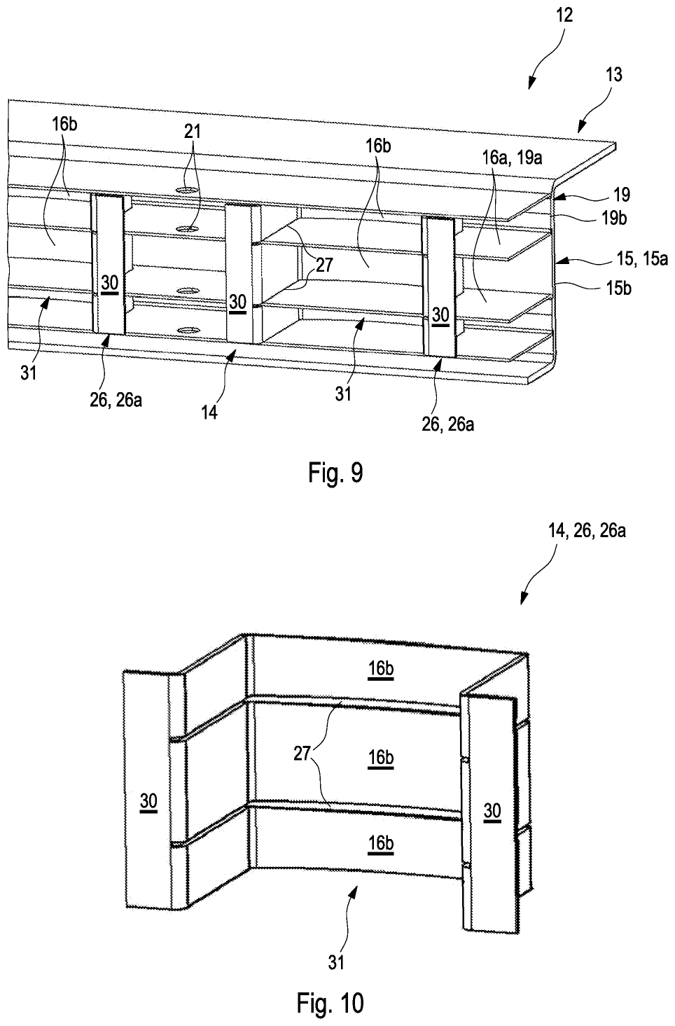

FIG. 9 shows a partial view of the differingly configured energy receiving arrangement 12. Here, the wall part 13 is formed identically to the wall part 13 shown in FIG. 4. The second gripping elements 16b of the beam part 14 are also arranged here into the gripping groups 26, which are arranged adjacent to one another. The respective gripping group 26 is formed here by a Ω-shaped profile 26a. Angled ends 30 of the profile 26a are able to be fixed on the beam 4 of the motor vehicle 1—not shown here—and the second gripping elements 16b are formed in a U-shaped central region 31 of the profile 26a by through-cuts 27. The first gripping elements 16a then engage into the through-cuts 27 in vehicle Y-direction. The gripping group 26 of the Ω-shaped profile 26a is shown more closely in FIG. 10.

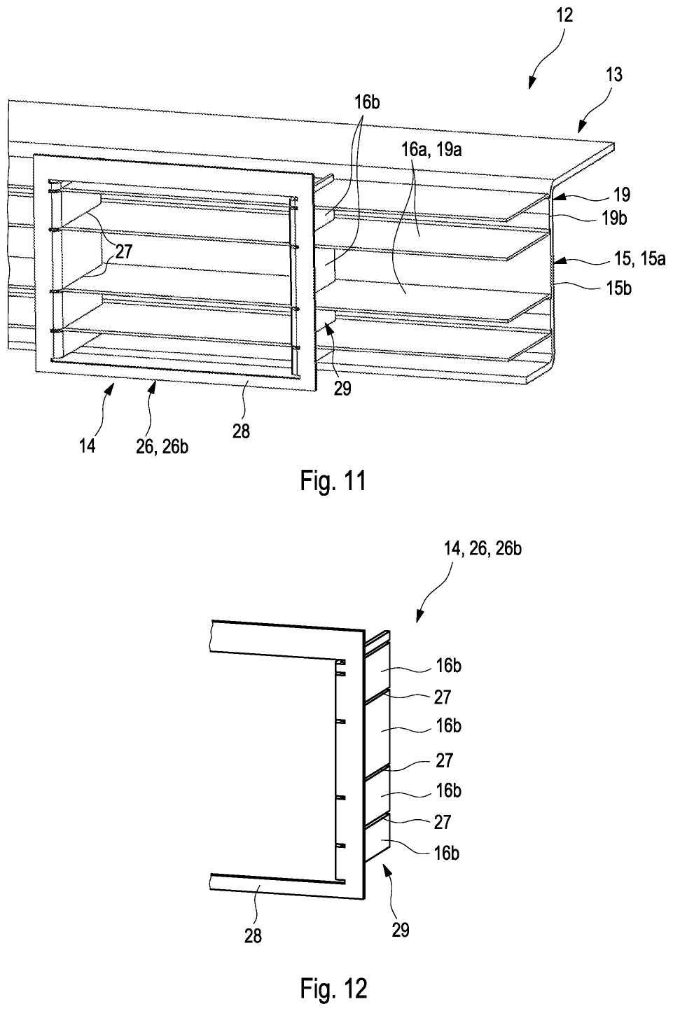

FIG. 11 shows a partial view of the differingly configured energy receiving arrangement 12. Here, the wall part 13 is formed identically to the wall part 13 shown in FIG. 4 and in FIG. 9. The second gripping elements 16b of the beam part 14 are also arranged here into the gripping groups 26 which are arranged adjacent to one another. The respective gripping group 26 is formed here by a grid plate 26b with a frame 28 and with a central region 29 angled from the frame 28 in vehicle Y-direction. The frame 28 of the grid plate 26b is able to be fixed to the beam of the motor vehicle 1—not shown here—and the second gripping elements 16b are formed in the angled central region 28 of the grid plate 26b by through-cuts 27. The gripping group 26 in the form of the grid plate 26b is shown more closely in FIG. 12.

In summary, the energy receiving arrangement 12 in the accumulator arrangement 2 according to the invention is able to be produced simply and at a favourable cost. The first gripping elements 16a and the second gripping elements 16b engage into one another here so that in the case of an impact the energy receiving arrangement 12 can receive the impact energy and can transfer it effectively to the beam 4 of the motor vehicle 1.

1. An accumulator arrangement with a plurality of battery modules for a motor vehicle, comprising:
an accumulator housing having a receiving space for receiving the plurality of battery modules;
the accumulator housing including a base and a wall projecting perpendicularly from the base in a wall direction;
at least one energy receiving arrangement configured to receive an impact energy in case of an impact, the at least one energy receiving arrangement including a wall part and a beam part, the wall part one of i) coupled on the wall of the accumulator housing and ii) defining the wall of the accumulator housing, and the beam part couplable on a beam of the motor vehicle; and
wherein the wall part includes a plurality of first gripping elements aligned transversely to the wall direction, the beam part includes a plurality of second gripping elements aligned transversely to the wall direction, and the plurality of first gripping elements and the plurality of second gripping elements engage into one another in an overlapping direction such that in the case of an impact the impact energy is received by the plurality of first gripping elements and the plurality of second gripping elements of the at least one energy receiving arrangement in the overlapping direction and the plurality of battery modules arrangeable in the accumulator housing can be are protected.

2. The accumulator arrangement according to claim 1, wherein:
the plurality of first gripping elements are coupled to a carrier plate of the wall part, which extends in the wall direction over an entire height and transversely to the wall direction over an entire length of the accumulator arrangement; and
the plurality of first gripping elements project from the carrier plate in the overlapping direction extend over an entire length of the carrier plate, and are arranged in the wall direction at least one of i) at an equal distance and ii) at an irregular distance with respect to one another.

3. The accumulator arrangement according to claim 2, wherein the carrier plate has one of a Z-shaped profile, a L-shaped profile, a C-shaped profile, and an I-shaped profile and wherein the plurality of first gripping elements coupled to a crosspiece of the carrier plate.

4. The accumulator arrangement according to claim 2, wherein at least one of:
the plurality of first gripping elements are respectively defined by a strip which projects from the carrier plate in the overlapping direction and is coupled on the carrier plate in a materially bonded manner;
two adjacently arranged first gripping elements of the plurality of first gripping elements are defined by a plurality of flanges of a U-shaped profile having a crosspiece coupled on the carrier plate in a materially bonded manner; and
the plurality of first gripping elements are defined by a folded plate which is coupled on one side on the carrier plate in a materially bonded manner.

5. The accumulator arrangement according to claim 1, wherein:
the plurality of second gripping elements are arranged into a plurality of gripping groups disposed adjacent to one another transversely to the wall direction, wherein each of the plurality of gripping groups extends in the wall direction over the entire height of the accumulator arrangement; and
the plurality of second gripping elements of a respective gripping group of the plurality of gripping groups are arranged in the wall direction one of i) at an equal distance and ii) at an irregular distance with respect to one another.

6. The accumulator arrangement according to claim 5, wherein at least one of:
the respective gripping group has a Ω-shaped profile having a plurality of angled ends couplable on the beam of the motor vehicle and having a U-shaped central region in which the plurality of second gripping elements of the respective gripping group are disposed;
the respective gripping group is defined by a grid plate with a frame and with a central region angled from the frame in the overlapping direction, the frame couplable on the beam of the motor vehicle, and the plurality of second gripping elements of the respective gripping group disposed in the angled central region; and
the respective gripping group is defined by a carrier plate and a folded plate defining the plurality of second gripping elements of the respective gripping group, the folded plate coupled on the carrier plate in a materially bonded manner.

7. The accumulator arrangement according to claim 6, wherein the plurality of second gripping elements are one of i) separated by and ii) defined by a plurality of through-cuts aligned in the overlapping direction, into which the plurality of first gripping elements engage in the overlapping direction.

8. The accumulator arrangement according to claim 1, wherein at least one of:
a height of the plurality of first gripping elements in the wall direction corresponds to a distance of the plurality of second gripping elements in the wall direction; and
a height of the plurality of second gripping elements in the wall direction corresponds to a distance of the plurality of first gripping elements in the wall direction.

9. The accumulator arrangement according to claim 1, wherein at least one of:
the plurality of second gripping elements respectively have at least one ramp region, directed to the plurality of first gripping elements facilitating introduction of the beam part into the wall part; and
at least one of i) the plurality of first gripping elements and ii) the plurality of second gripping elements respectively have a tooth-like region for engagement behind such that the plurality of first gripping elements and the plurality of second gripping elements do not engage behind one another when bringing together the beam part and the wall part, and engage behind one another upon separating the beam part and the wall part in the overlapping direction.

10. The accumulator arrangement according to claim 1, further comprising a plurality of tension anchor openings, lying over one another in the wall direction, disposed in at least one of i) the plurality of first gripping elements and ii) the plurality of second gripping elements, wherein the plurality of tension anchor openings are configured to receive a tension anchor.

11. A motor vehicle, comprising a beam and an accumulator arrangement coupled beneath the motor vehicle on a body floor, the accumulator arrangement including:
an accumulator housing defining a receiving space for receiving a plurality of battery modules, the accumulator housing including a base and a wall projecting perpendicularly from the base in a wall direction;
at least one energy receiving arrangement configured to receive an impact energy in case of an impact, the at least one energy receiving arrangement including a wall part and a beam part, the wall part one of i) coupled on the wall of the accumulator housing and ii) defining the wall of the accumulator housing;
the wall part including a plurality of first gripping elements aligned transversely to the wall direction, the beam part including a plurality of second gripping elements aligned transversely to the wall direction, the plurality of first gripping elements and the plurality of second gripping elements engaging in one another in an overlapping direction such that, in the case of an impact, the impact energy is received by the plurality of first gripping elements and the plurality of second gripping elements of the at least one energy receiving arrangement in the overlapping direction and the plurality of battery modules arranged in the accumulator housing are protected; and
wherein the beam part of the at least one energy receiving arrangement is coupled on the beam, and wherein the wall direction of the accumulator arrangement corresponds to a vehicle Z-direction, and the overlapping direction of the accumulator arrangement corresponds to one of a vehicle X-direction and a vehicle Y-direction.

12. The accumulator arrangement according to claim 1, wherein the plurality of second gripping elements respectively have at least one ramp region directed to the plurality of first gripping elements facilitating introduction of the beam part into the wall part.

13. The accumulator arrangement according to claim 1, wherein at least one of i) the plurality of first gripping elements and ii) the plurality of second gripping elements, respectively have a tooth-like region structured and arranged such that the plurality of first gripping elements and the plurality of second gripping elements do not engage behind one another when bringing together the beam part and the wall part, and engage behind one another upon separating the beam part and the wall part in the overlapping direction.

14. The accumulator arrangement according to claim 2, wherein at least one of the plurality of first gripping elements is defined by a strip projecting from the carrier plate in the overlapping direction and coupled on the carrier plate in a materially bonded manner.

15. The accumulator arrangement according to claim 2, wherein two adjacently arranged first gripping elements of the plurality of first gripping elements are defined by a respective flange of a U-shaped profile having a crosspiece coupled on the carrier plate in a materially bonded manner.

16. The accumulator arrangement according to claim 2, wherein at least one of the plurality of first gripping elements is defined by a folded plate which is coupled on one side on the carrier plate in a materially bonded manner.

17. The accumulator arrangement according to claim 5, wherein the respective gripping group has a Ω-shaped profile having a plurality of angled ends couplable on the beam of the motor vehicle and having a U-shaped central region in which the plurality of second gripping elements of the respective gripping group are disposed.

18. The accumulator arrangement according to claim 5, wherein the respective gripping group is defined by a grid plate with a frame and with a central region angled from the frame in the overlapping direction, the frame is couplable on the beam of the motor vehicle, and the plurality of second gripping elements of the respective gripping group are disposed in the angled central region.

19. The accumulator arrangement according to claim 5, wherein the respective gripping group is defined by a carrier plate and a folded plate defining the plurality of second gripping elements of the respective gripping group, and wherein the folded plate is coupled on the carrier plate in a materially bonded manner.

20. An accumulator arrangement for a motor vehicle, comprising:
an accumulator housing defining a receiving space structured to receive a plurality of battery modules, the accumulator housing including a base and a wall, the wall protruding from the base in a wall direction;
at least one energy receiving arrangement including a wall part and a beam part, the wall part one of i) coupled to the wall of the accumulator housing and ii) defining the wall of the accumulator housing, the beam part couplable on a beam of the motor vehicle;
the wall part including a plurality of first gripping element extending along an overlapping direction and disposed above one another relative to the wall direction, the overlapping direction extending transversely to the wall direction;
the beam part including a plurality of second gripping element extending along the overlapping direction and disposed above one another relative to the wall direction;
the plurality of first gripping elements and the plurality of second gripping elements engaging one another such that the plurality of first gripping elements and the plurality of second gripping elements are alternatingly disposed relative to the wall direction; and
wherein the plurality of first gripping elements and the plurality of second gripping elements are deformable via an impact energy.
